(19) United States
(12) Patent Application Publication
(10) Pub. No.: US 2019/0378358 A1
(43) Pub. Date: Dec. 12, 2019

(54) Method, System, Computer Program and Computer Program Product for Performing a Vehicle-Based Service

(71) Applicant: Bayerische Motoren Werke Aktiengesellschaft, Muenchen (DE)

(72) Inventor: Michael REITBERGER, Neuried (DE)

(21) Appl. No.: 16/546,774

(22) Filed: Aug. 21, 2019

Related U.S. Application Data
(63) Continuation of application No. PCT/EP2018/062048, filed on May 9, 2018.

(30) Foreign Application Priority Data
May 31, 2017 (DE) 10 2017 209 197.5

(51) Int. Cl. G07C 5/00; H04W 12/06; H04W 4/40; H04W 4/80

(52) U.S. Cl. CPC G07C 5/008; H04W 4/80; H04W 4/40; H04W 12/0608

(57) ABSTRACT

A method for performing a vehicle-based service by way of a mobile unit involves the mobile unit being used to send first request data to a vehicle unit. The vehicle unit is used to send second request data to a service unit on the basis of the first request data. The service unit is used to send authorization data to the vehicle unit on the basis of the second request data. The vehicle unit is used to send the authorization data to the mobile unit on the basis of the authorization data from the service unit. The mobile unit is used to communicate with the service unit on the basis of the authorization data from the vehicle unit to perform the service.

### CROSS REFERENCE TO RELATED APPLICATIONS

This application is a continuation of PCT International Application No. PCT/EP2018/062048, filed May 9, 2018, which claims priority under 35 U.S.C. § 119 from German Patent Application No. 10 2017 209 197.5, filed May 31, 2017, the entire disclosures of which are herein expressly incorporated by reference.

### BACKGROUND AND SUMMARY OF THE INVENTION

The invention relates to a method for performing an onboard service by way of a mobile unit. The invention additionally relates to a system for performing an onboard service by way of the mobile unit. The invention additionally relates to a computer program and a computer program product for performing an onboard service by way of the mobile unit.

In modern vehicles, services are frequently provided on an onboard basis. Such services are, for example, telematics and information services, such as an enquiry service, for example a concierge call, realtime traffic information, music streaming services and the like. These services are provided by the respective vehicle manufacturer, for example. The services are activated either by means of additional purchase of special equipment or by means of subsequent activation via a customer portal. A prerequisite for the use of the digital services is for example the integration of a telematics controller with a mobile radio link.

The object on which the invention is based is to simplify the use of onboard services.

According to the invention, a method is provided for performing an onboard service by way of a mobile unit. The method involves the mobile unit being used to send first request data to a vehicle unit. The vehicle unit is used to take the first request data as a basis for sending second request data to a service unit. The service unit is used to take the second request data as a basis for sending authorization data to the vehicle unit. The vehicle unit is used to take the authorization data as a basis for sending the authorization data to the mobile unit. The mobile unit is used to take the authorization data as a basis for communicating with the service unit to perform the service.

The invention is additionally distinguished by a system for performing the onboard service by way of the mobile unit, having the mobile unit, the vehicle unit and the service unit, wherein the system is designed to perform the method for performing an onboard service.

The method can be used to carry out the respective service with the mobile unit. Since the authorization is provided by means of the vehicle unit, however, it is possible to ensure that the service is carried out only in, or in the surroundings of, the vehicle and not without the vehicle. This allows the service to be used in a mobile and hence simpler and more user friendly manner.

The mobile unit can be in the form of a smartphone, a tablet PC and/or a laptop, for example.

The second request data can be identical to the first request data, for example. Alternatively, the first request data can also be processed in the vehicle unit and nonidentical second request data can be sent.

The first request data comprise information pertaining to the mobile unit and/or information pertaining to a selected service, for example. The second request data comprise an authorization request for the mobile unit for the selected service, for example.

According to an optional configuration, the authorization data have an authentication key and a timestamp.

The authentication key and the timestamp can be used to ensure that the service can be used for a prescribed time, for example a single-digit range of minutes. After that, a new authorization key can be requested, for example. This allows the service to be used for a certain time after the vehicle has left as well. This is advantageous in particular in the case of a service for taking someone home through dangerous areas or in the case of a service for looking for what is known as a POI, that is a “Point of Interest”.

According to a further optional configuration, the mobile unit is used to take the authorization data and to take a communication connection to the vehicle unit as a basis for communicating with the service unit to perform the service.

The effect that can be achieved by this is that the service is performed only in the event of an existing communication connection between mobile unit and vehicle unit, for example. Therefore, it can be achieved that the service can be used only in direct proximity to the vehicle. Alternatively or additionally, it is also possible for the service to be permitted to continue to be used for a limited time after the communication connection is terminated.

According to a further optional configuration, the mobile unit uses a first communication interface of the mobile unit to communicate with the vehicle unit and uses a second communication interface of the mobile unit to communicate with the service unit.

The two communication interfaces allow the mobile unit to communicate with the vehicle unit and the service unit at the same time, so that the service can be provided more quickly.

According to a further optional configuration, the first communication interface of the mobile unit is a Bluetooth interface.

According to a further optional configuration, the second communication interface of the mobile unit is a mobile radio interface.

According to a further optional configuration, the vehicle unit uses a first communication interface of the vehicle unit to communicate with the mobile unit and uses a second communication interface of the vehicle unit to communicate with the service unit.

The two communication interfaces allow the vehicle unit to communicate with the mobile unit and the service unit at the same time, so that the service can be provided more quickly.

According to a further optional configuration, the first communication interface of the vehicle unit is a Bluetooth interface.

According to a further optional configuration, the second communication interface of the vehicle unit is a mobile radio interface.

According to a further optional configuration, the vehicle unit is permanently installed in a motorcycle.

Particularly in motorcycles, the use of a service by means of the vehicle unit is not very easy. It is therefore advantageous, particularly in the case of a motorcycle, to use the mobile unit to perform a service.

According to a further aspect, the invention is distinguished by a computer program, wherein the computer program is designed to perform the method for performing an onboard service.

According to a further aspect, the invention is distinguished by a computer program product that comprises an executable program code, wherein the program code carries out the method for performing an onboard service when executed by a data processing apparatus.

The computer program product in particular comprises a medium readable by the data processing apparatus and storing the program code.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic block diagram of an exemplary system for performing an onboard service.

FIG. 2 is an exemplary flowchart for performing an onboard service.

### DETAILED DESCRIPTION OF THE DRAWINGS

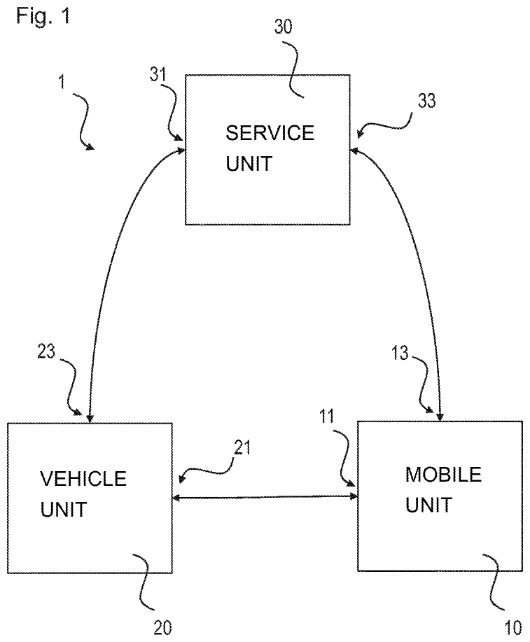

FIG. 1 shows a system for performing an onboard (vehicle-based) service.

The system 1 comprises a mobile unit 10. The mobile unit 10 comprises a computing unit, a program and data memory and also a first communication interface 11 and a second communication interface 13. The program and data memory and/or the computing unit and/or the communication interfaces 11, 13 can be in a form in one assembly and/or distributed over multiple assemblies.

The mobile unit 10 can be in the form of a smartphone, a tablet PC and/or a laptop, for example.

The system 1 additionally comprises a vehicle unit 20. The vehicle unit 20 comprises a computing unit, a program and data memory and also a first communication interface 21 and a second communication interface 23. The program and data memory and/or the computing unit and/or the communication interfaces 21, 23 can be in a form in one assembly and/or distributed over multiple assemblies.

The vehicle unit 20 can be permanently arranged in a vehicle, such as a motorcycle, for example.

The system 1 additionally comprises a service unit 30. The service unit 30 comprises a computing unit, a program and data memory and also a first communication interface 31 and a second communication interface 33. The program and data memory and/or the computing unit and/or the communication interfaces 31, 33 can be in a form in one assembly and/or distributed over multiple assemblies. The two communication interfaces 31, 33 can also be in a form in a communication interface.

The service unit 30 is in a form outside the vehicle, for example in a backend. The mobile unit 10 and the vehicle unit 20 can use their first communication interfaces 11, 21 to communicate with one another. The first communication interface 11 of the mobile unit 10 and the first communication interface 21 of the vehicle unit 20 are Bluetooth interfaces, for example.

The mobile unit 10 and the vehicle unit 20 can use their second communication interfaces 13, 23 to communicate with the service unit 30. The second communication interface 13 of the mobile unit 10 and the second communication interface 23 of the vehicle unit 20 are mobile radio interfaces, for example.

The system 1 can be used to carry out an onboard service. The program and data memory of the mobile unit 10, the vehicle unit 20 and the service unit 30 stores a program for this purpose, in particular.

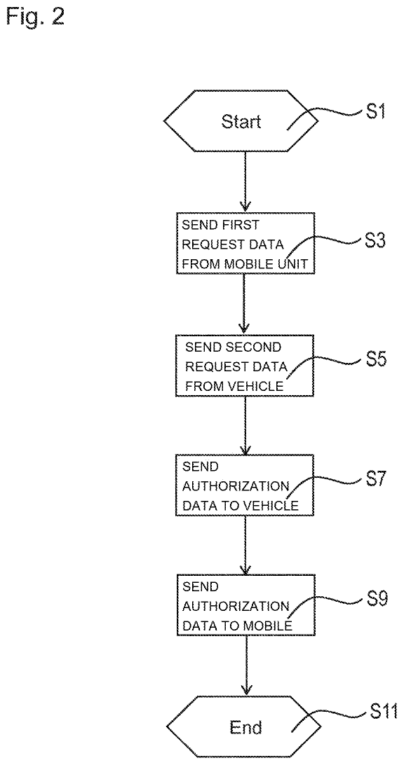

FIG. 2 shows a flowchart of the program for performing an onboard service.

The program is started in a step S 1, in which variables can be initialized if need be. The program can be started by means of an app on the mobile unit 10, for example.

In a step S3, first request data are sent from the mobile unit 10 to the vehicle unit 20. The first request data comprise information pertaining to the mobile unit 10 and/or information pertaining to a selected service, for example.

In a step S5, second request data are sent from the vehicle unit 20 to the service unit 30 on the basis of the first request data. The second request data comprise an authorization request for the mobile unit 10 for the selected service, for example.

In a step S7, the service unit 30 takes the second request data as a basis for sending authorization data to the vehicle unit 20. If the selected service is activated and/or available, then the authorization data comprise an authentication key and a timestamp, for example. If the selected service is not available, then the authorization data comprise a denial and/or a default key that cannot be used to use the service, for example.

In a step S9, the vehicle unit 20 takes the authorization data as a basis for sending the authorization data to the mobile unit 10.

If the authorization data comprise the authentication key and the timestamp, then the mobile unit 10 can now communicate with the service unit 30 and perform the service, for example.

The authentication key and the timestamp can be used to ensure that the service can be used for a prescribed time, for example a single-digit range of minutes. After that, a new authorization key can be requested, for example. This allows the service to be used for a certain time after the vehicle has left as well. Alternatively or additionally, the service can also be performed only in the event of an existing communication connection between the mobile unit 10 and the vehicle unit 20, for example. Therefore, the effect that can be achieved by this is that the service can be used only in direct proximity to the vehicle. Alternatively or additionally, it is also possible for the service to be permitted to continue to be used for a limited time after the communication connection is terminated.

In a step S11, the program is ended and can be started again if need be in step S1.

The method can be used to carry out the respective selected service with the mobile unit 10. Since the authorization is provided by way of the vehicle unit 20, however, it is possible to ensure that the service is carried out only in, or in the surroundings of, the vehicle and not without the vehicle. This allows the service to be used in a mobile and hence simpler and more user friendly manner.

Such services are for example telematics and information services, such as an enquiry service, for example a concierge call, realtime traffic information, music streaming services, a service for looking for what is known as a POI, that is to say a “Point of Interest”, a service for taking a person home through dangerous areas and/or an emergency service. Exemplary services are explained more specifically once again below.

In order to use a “voice call information service”, a user starts the service by means of an app. When the service has been started and confirmed using a valid authentication key, the service can then be used for a time that is to be defined. After that, a new authentication key needs to be requested. A voice call service is often problematic for motorcycles. For motorcyclists, the method provides the opportunity to use the mobile unit 10 for voice communication, which is more practical and easier than a communication unit permanently installed in the motorcycle.

It is also possible for the service to continue to be used for a limited time after the communication connection to the vehicle unit 20 is terminated. As a result, the user can, in certain cases, also continue to be assisted after the vehicle has left, e.g. looking for a POI or to take him home through areas presenting personal danger.

Furthermore, POIs requested by means of the voice call can be transmitted to the mobile unit 10. These can be used e.g. for navigation outside the vehicle too.

Furthermore, the voice call can be used to make a high-quality emergency call. A handsfree function as in the case of automobiles is often problematic for motorcycles. For motorcyclists, it provides the opportunity to use emergency calling with proper voice communication via the mobile unit 10.

### LIST OF REFERENCE SIGNS

System 1
Mobile unit 10
Communication interface 11
Communication interface 13
Vehicle unit 20
Communication interface 21
Communication interface 23
Service unit 30
Communication interface 31
Communication interface 33
Steps S1-S11

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for performing an onboard service via a mobile unit, comprising the acts of:
sending, by the mobile unit, first request data to a vehicle unit;
sending, by the vehicle unit, second request data based on the first request data to a service unit;
sending, by the service unit, authorization data based on the second request data to the vehicle unit;
sending, by the vehicle unit, authorization data to the mobile unit based on the authorization data from the service unit; and
using, by the mobile unit, the authorization data as a basis for communicating with the service unit to perform the onboard service.

2. The method according to claim 1, wherein the authorization data have an authentication key and a timestamp.

3. The method according to claim 1, wherein the mobile unit takes the authorization data and takes a communication connection to the vehicle unit as a basis for communicating with the service unit to perform the onboard service.

4. The method according to claim 1, wherein
the mobile unit uses a first communication interface of the mobile unit to communicate with the vehicle unit and uses a second communication interface of the mobile unit to communicate with the service unit.

5. The method according to claim 4, wherein
the first communication interface of the mobile unit is a Bluetooth interface.

6. The method according to claim 5, wherein
the second communication interface of the mobile unit is a mobile radio interface.

7. The method according to claim 1, wherein
the vehicle unit uses a first communication interface of the vehicle unit to communicate with the mobile unit and uses a second communication interface of the vehicle unit to communicate with the service unit.

8. The method according to claim 7, wherein
the first communication interface of the vehicle unit is a Bluetooth interface.

9. The method according to claim 8, wherein
the second communication interface of the vehicle unit is a mobile radio interface.

10. The method according to claim 1, wherein the vehicle unit is permanently installed in a motorcycle.

11. A method for performing an onboard service via a mobile unit, the method comprising the acts of:
receiving, by a vehicle unit, first request data from the mobile unit;
sending, by the vehicle unit, second request data to a service unit based on the first request data;
receiving, by the vehicle unit, authorization data from the service unit based on the second request data;
sending, by the vehicle unit, authorization data to the mobile unit based on the authorization data from the service unit, wherein
the authorization data sent to the mobile unit is usable by the mobile unit to communicate with the service unit based on the authorization data to perform the onboard service.

12. The method according claim 11, wherein
the sent authorization data to the mobile unit comprises an authentication key and a time stamp.

13. A system for performing an onboard service, comprising:
a mobile unit;
a vehicle unit; and
a service unit, wherein the system is configured to carry out the acts of:
sending, by the mobile unit, first request data to a vehicle unit;
sending, by the vehicle unit, second request data based on the first request data to a service unit;
sending, by the service unit, authorization data based on the second request data to the vehicle unit;
sending, by the vehicle unit, authorization data to the mobile unit based on the authorization data from the service unit; and
using, by the mobile unit, the authorization data as a basis for communicating with the service unit to perform the onboard service.

14. A computer product comprising a non-transitory computer readable medium having stored thereon program code that, when executed, carries out the acts of:
sending, by the mobile unit, first request data to a vehicle unit;
sending, by the vehicle unit, second request data based on the first request data to a service unit;
sending, by the service unit, authorization data based on the second request data to the vehicle unit;
sending, by the vehicle unit, authorization data to the mobile unit based on the authorization data from the service unit; and
using, by the mobile unit, the authorization data as a basis for communicating with the service unit to perform the onboard service.
